(19) United States
(12) Patent Application Publication
(10) Pub. No.: US 2022/0198279 A1
(43) Pub. Date: Jun. 23, 2022

(54) Data-Driven Methodology for Automatic Detection of Data Drift

(71) Applicant: The Boeing Company, Chicago, IL (US)

(72) Inventors: Rashmi Nandipura Sundareswara, Topanga, CA (US); James Schimert, Seabeck, WA (US); Tsai-Ching Lu, Thousand Oaks, CA (US); Franz David Betz, Renton, WA (US)

(73) Assignee: The Boeing Company, Chicago, IL (US)

(21) Appl. No.: 17/554,630

(22) Filed: Dec. 17, 2021

Related U.S. Application Data
(60) Provisional application No. 63/127,378, filed on Dec. 18, 2020.

(51) Int. Cl. G06N 3/08

(52) U.S. Cl. CPC G06N 3/088

(57) ABSTRACT

A system and method for drift detection is disclosed. The method may comprise training and testing an autoencoder, and using the trained and tested autoencoder to automatically detect data drift. The training may include initializing the autoencoder and training the autoencoder based on a first set of sensor data. The testing of the autoencoder with a second set of sensor data may comprise: for an empirical distribution of the reconstruction errors of the second set of sensor data, determining a value of a reconstruction error at the percentile threshold; determining that data drift is not present when the reconstruction error of the second set of sensor data is less than a threshold; and calculating a deviation output for at least one of the one or more sensors. Using the trained and tested autoencoder to automatically detect data drift in sensor data.

### CROSS-REFERENCE TO RELATED APPLICATIONS

This application claims priority to, and the benefit of, U.S. Provisional Patent Application No. 63/127,378 filed Dec. 18, 2020, the disclosure of which is hereby incorporated by reference in its entirety.

### TECHNICAL FIELD

The present disclosure generally relates to systems and methods of detecting drift in data collected over time.

### BACKGROUND

Data is collected over time from sensors on aircraft and other machines and vehicles for a variety of purposes. Classifiers, unsupervised or supervised, may be used to analyze such data. Common uses of classifiers may include, but are not limited to, analysis of performance of a component (e.g., an aircraft component), machine or system, as well as identification of a need for inspection, maintenance or repair of such. The use of a classifier is based on the assumption that the incoming data points are statistically similar to the data set that was used to train the classifier.

Drift is a phenomenon by which data collected from sensors monitoring a component or machine, or the like, starts to look different over time than what is expected. This may happen due to a number of reasons such as: aging sensors, aging parts which the sensor is monitoring, or a change in operation environment of the part or machine from that which was utilized to train the system that monitors the data provided by the sensors.

Typically, there are two different approaches to addressing data drift. The first analyzes the distribution of the data and determines if parameters of the distribution have changed. For example, the statistics of each individual sensor that contribute to the data stream is examined separately for drift. Once significantly statistical change has been detected, the classifier is re-trained to update the classifier operation. The disadvantage of this approach is that one will need as many thresholds as the number of sensors and this method does not account for the fact that there is correlation among sensor variables. This approach can be unwieldy because of the number of distribution parameters that must be monitored (which can grow in number up to the number of sensor variables).

A second method of assessing data drift is to do so through analyzing the error rate or error-driven statistics on the classification error. For example, tracking the changing statistics of multiple elements of a multi-class confusion matrix and detecting drift based on significantly changed statistics of any of the elements as a function of time. The disadvantage of this methodology is that it only applies to supervised learning classifiers (not unsupervised learning classifiers) since computing the confusion matrix requires labeled data.

Undetected drift in the data stream received from sensors effects the analysis and possibly the conclusions drawn from the sensor data. An effective method of detecting drift in data streams received by a supervised or unsupervised classifier is desired.

### SUMMARY

In accordance with one aspect of the disclosure, a data drift detection system is disclosed. The data drift detection system may comprise an autoencoder configured to receive a first set of sensor data and a second set of sensor data; and a training controller. The training controller may be configured to: train the autoencoder based on a first portion of the first set of sensor data; set an initial threshold to a value x at a percentile threshold of an empirical distribution of the reconstruction errors of the first portion of the first set of sensor data after decoding by a decoder layer of the autoencoder; and determine a final threshold based on a comparison of an empirical distribution of the reconstruction errors of a second portion of the first set of sensor data to the empirical distribution of the reconstruction errors of the first portion of the first set of sensor data; and a testing controller configured to test the autoencoder with the second set of sensor data.

In accordance with another aspect of the disclosure, a method for detecting data drift is disclosed. The method may comprise: training an autoencoder, and testing the autoencoder with a second set of sensor data detected by one or more sensors. The training may include: initializing the autoencoder, the autoencoder including an input layer, an encoder layer and a decoder layer; training the autoencoder based on a first portion of a first set of sensor data; setting an initial threshold to a value x at a percentile threshold of an empirical distribution of the reconstruction errors of the first portion of the first set of sensor data after decoding by the decoder layer; and determining a final threshold based on a comparison of an empirical distribution of the reconstruction errors of a second portion of the first set of sensor data to the empirical distribution of the reconstruction errors of the first portion of the first set of sensor data. The testing of the autoencoder with a second set of sensor data detected by one or more sensors may comprise: for an empirical distribution of the reconstruction errors of the second set of sensor data after decoding by the decoder layer, determining a value of a reconstruction error at the percentile threshold; determining that data drift is not present when the reconstruction error of the second set of sensor data is less than the final threshold; and calculating a deviation output for at least one of the one or more sensors.

In accordance with a further aspect of the disclosure, a method for detecting drift in data captured by a plurality of sensors monitoring an operation of an aircraft system is disclosed. The method may comprise training a three-layer autoencoder; testing the autoencoder with a second set of sensor data from a second plurality of sensors; and after training and the testing the autoencoder, detecting whether data drift is present in a third set of sensor data received from a third plurality of sensors. The training may include initializing the autoencoder, the autoencoder including an input layer, an encoder layer and a decoder layer. The training may further include training the autoencoder based on a first portion of a first set of sensor data, the first set of sensor data detected by a first plurality of sensors; setting an initial threshold to a value x at a percentile threshold of an empirical distribution of the reconstruction errors of the first portion of the first set of sensor data after decoding by the decoder layer, wherein the percentile threshold is 90-99.7; comparing an empirical distribution of the reconstruction errors of a second portion of the first set of sensor data to the empirical distribution of the reconstruction errors of the first portion of the first set of sensor data; and determining a final threshold based on a result of the comparing. The testing of the autoencoder with the second set of sensor data from the second plurality of sensors may comprise: receiving, encoding and decoding the second set of sensor data with the autoencoder; for an empirical distribution of the reconstruction errors of the second set of sensor data after decoding by the decoder layer, determining a value of a reconstruction error at the percentile threshold; comparing the reconstruction error of the second set of sensor data with the final threshold; determining that data drift is not present in the second set of sensor data when the reconstruction error of the second set of sensor data is less than the final threshold; and calculating a deviation output for one or more sensors in the second plurality of sensors.

### BRIEF DESCRIPTION OF THE DRAWINGS

FIG. 1A depicts an example of a system for training and testing an autoencoder to detect data drift according to the disclosure;

FIG. 1B depicts an example of another system according to the disclosure;

FIG. 2 depicts an example of a method of training an autoencoder, in accordance with an example of the present disclosure;

FIG. 3 illustrates an example of a method of testing an autoencoder, in accordance with an example of the present disclosure;

FIG. 4 illustrates an exemplary deviation output for each of one or more sensors in a plurality of sensors;

FIG. 5 illustrates an example of a method of determining if data drift is present using a trained and tested autoencoder in accordance with the present disclosure; and

FIG. 6 illustrates an exemplary embodiment of a sliding window, an input layer, an encoder layer and a decoder layer.

### DETAILED DESCRIPTION

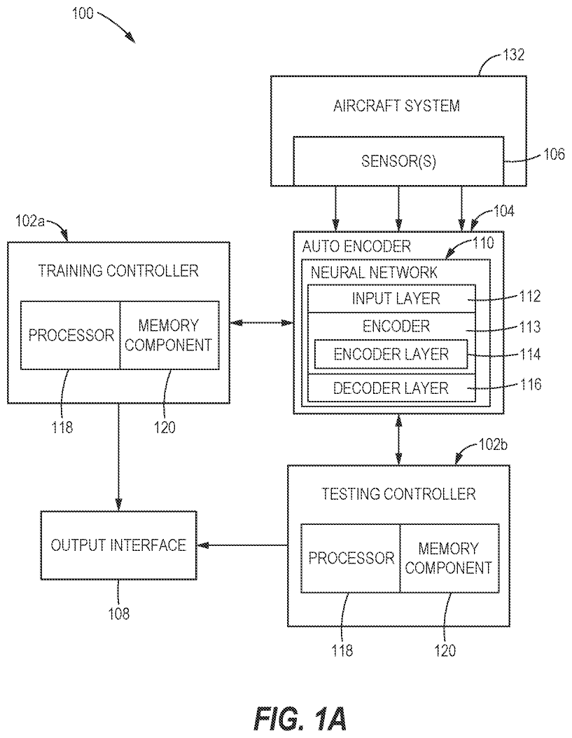

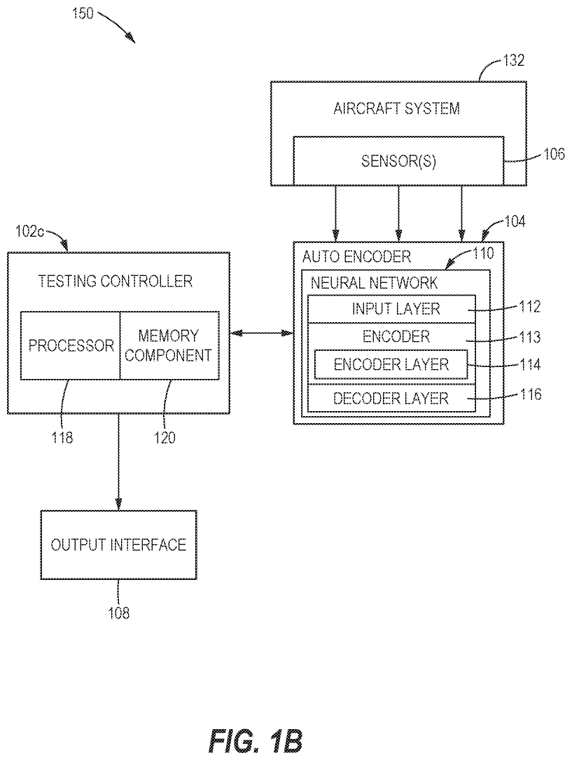

FIG. 1A illustrates an example of a system 100 for training and testing an autoencoder 104 to recognize when incoming data from one or more sensors 106 or the like to an autoencoder 104, has changed or drifted from the data that the autoencoder 104 was trained on. The system 100 includes a training controller 102a in operable communication with an autoencoder 104. The system 100 further includes one or more sensors 106 in operable communication with the autoencoder 104. The system 100 may also include an output interface 108 in operable communication with the controller 102.

The autoencoder 104 is configured to be an unsupervised neural network 110 that includes an input layer 112, an encoder 113 and a decoder layer 116. The autoencoder 104 is configured to learn efficient data codings in an unsupervised manner. More specifically, the autoencoder 104 learns a representation (encoding) for a set of data, typically for dimensionality reduction, by training the neural network 110 to ignore signal noise.

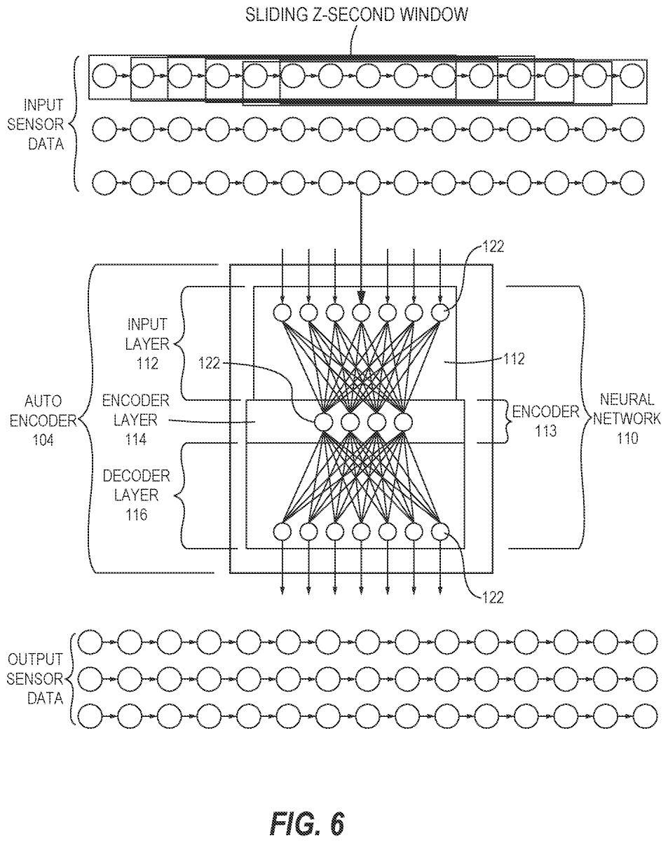

The input layer 112 receives data from one or more sensors 106 (“sensor data”) and includes a plurality of neurons 122 (see FIG. 6).

Each sensor 106 (FIG. 1A) is configured to detect and/or capture measurements of operating or performance parameters (“sensor data”) of a component, machine or system, and to provide such sensor data to the autoencoder 104. In the exemplary embodiment each sensor 106 is disposed to monitor an aircraft system 132 (e.g., a cabin compressor system) and is configured to detect sensor data associated with the operation or performance of such aircraft system 132. In other embodiment, the sensors 106 may monitor other systems or components or machines, including those not associated with aircraft.

The encoder 113 includes one or more encoder layers 114. Each encoder layer 114 includes a plurality of neurons 122 (see FIG. 6). In the embodiment disclosed herein, the encoder 113 utilizes one encoder layer 114. However, in other embodiments, the encoder 113 may include more than one encoder layer 114. The encoder 113 is configured to be trained to learn the structure of the data received by the input layer 112. In the exemplary embodiment the structure is learned by backpropagation.

The decoder layer 116 is configured to reconstruct the data received from the encoder 113 into the data received by the input layer 112. The decoder layer 116 is configured to reconstruct the data into the size of the input layer 112 and the size of the decoder layer 116 is set equal to the size of the input layer 112. This allows a direct comparison of the accuracy of the encoder 113 and from such comparison a measurement of the drift (if any) that may be present. This difference between the input and the reconstructed output may be used as a measure of how well the encoder 113 has learned the structure in the sensor data.

The training controller 102a (FIG. 1A) is in operable communication with the autoencoder 104 and the output interface 108. In some embodiments a plurality of controllers may be utilized. For example, as seen in FIG. 1A, the system 100 includes the training controller 102a and a testing controller 102b.

The training controller 102a may be configured to determine empirical distributions of the reconstruction errors of the training set of sensor data after decoding by the decoder layer 116 and to determine empirical distributions of the reconstruction errors of the holdout set of sensor data after decoding by the decoder layer 116, as described later herein. The controller 102a is configured to set an initial threshold to a value “x” that is the value at a selected percentile (“percentile threshold”) of an empirical distribution of the reconstruction errors of the training set. The training controller 102a is configured to assess the initial threshold x using the holdout set of sensor data and to determine a final threshold for the autoencoder 104, as described later herein.

The testing controller 102b is configured to determine for an empirical distribution of the reconstruction errors of a sample set of sensor data (after decoding by the decoder layer 116) a value of the reconstruction error (e) at the percentile threshold that was previously determined for the autoencoder 104 during training, as discussed later herein. The testing controller 102b is configured to compare the value of the reconstruction error (e) of the sample set of sensor data with the value of the final threshold that was determined with the training data and to determine if data drift is present or not, as described later herein. The testing controller 102b may be configured to calculate a deviation output, if any, for one or more of the sensors 106 in the plurality of sensors 106 from which the sample set of sensor data was received and may be configured to transmit the result (data drift present or not present) and/or the deviation output, if any, to the output interface 108.

FIG. 1B is similar to FIG. 1A except that the system 150 illustrated includes the autoencoder 104 after it has been trained and tested to recognize when incoming data from one or more sensors 106 has changed or drifted from the data that the autoencoder 104 was trained on. Similar to the system 100 of FIG. 1A, the system of FIG. 1B includes a testing controller 102c in operable communication with the autoencoder 104. In the system 150, the one or more sensors 106 are in operable communication with the autoencoder 104. The system 150 may also include an output interface 108 in operable communication with the testing controller 102c.

The testing controller 102c is configured to determine for an empirical distribution of the reconstruction errors of a set of sensor data (after decoding by the decoder layer) a value of the reconstruction error (e) at the percentile threshold that was previously determined for the autoencoder 104, as discussed later herein. The testing controller 102c is configured to compare the value of the reconstruction error (e) of the set of sensor data with the value of the final threshold that was set for the autoencoder 104 and to determine if data drift is present or not, as described later herein. The testing controller 102c may be configured to calculate a deviation output, if any, for one or more of the sensors 106 in the plurality of sensors 106 from which the set of sensor data was received and may be configured to transmit the result (data drift present or not present) and/or the deviation output, if any, to the output interface 108.

Each controller 102a, 102b, 102c (collectively, controller 102) may include a processor 118 and a memory component 120. The processor 118 may be a microcontroller, a digital signal processor (DSP), an electronic control module (ECM), an electronic control unit (ECU), a microprocessor or any other suitable processor 118 as known in the art. The processor 118 may execute instructions and generate control signals for executing appropriate blocks of the methods described herein. Such instructions may be read into or incorporated into a computer readable medium, such as the memory component 120 or provided external to the processor 118. In alternative examples, hard wired circuitry may be used in place of, or in combination with, software instructions to implement a control method.

The term “computer readable medium” as used herein refers to any non-transitory medium or combination of media that participates in providing instructions to the processor 118 for execution. Such a medium may comprise all computer readable media except for a transitory, propagating signal. Common forms of computer-readable media include, for example, a floppy disk, a flexible disk, hard disk, magnetic tape, or any other magnetic medium, a CD-ROM, any other optical medium, or any other computer readable medium.

Each controller 102a, 102b, 102c is not limited to one processor 118 and memory component 120. The controller 102a, 102b, 102c may include several processors 118 and memory components 120. In an example, the processors 118 may be parallel processors that have access to a shared memory component(s) 120. In another example, the processors 118 may be part of a distributed computing system in which a processor 118 (and its associated memory component 120) may be located remotely from one or more other processor(s) 118 (and associated memory components 120) that are part of the distributed computing system. The controller 102a, 102b, 102c may also be configured to retrieve from the memory component 120 and formulas and other data necessary for the calculations discussed herein.

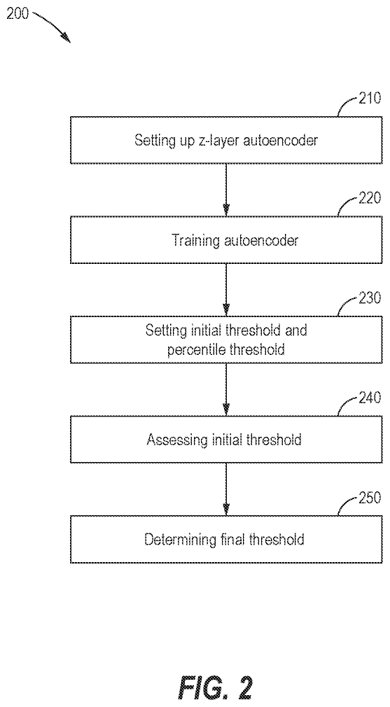

Referring now to FIG. 2 an exemplary flowchart is illustrated showing sample blocks in a method 200 to train the autoencoder 104.

Block 210 includes initializing the autoencoder 104. Initializing includes setting up a z-layer autoencoder 104. In the exemplary embodiment described here, z=3 and thus, the autoencoder 104 is a three-layer autoencoder. Namely, the autoencoder 104 includes an input layer 112, an encoder layer 114 (i.e., the encoder 113 includes a single encoder layer) and a decoder layer 116. As mentioned earlier, a larger number of layers may be utilized (e.g., the encoder 113 may include multiple encoder layers 114).

The input data may be captured by each of “i” sensors for a sliding n-second window of time. For example, in the exemplary embodiment i=24 and n=10 and the interval=1 (second), thus there are twenty-four (24) sensors 106 (also known as sensor variables) configured to measure operating or performance parameters of the component, machine or system (in the exemplary embodiment, cabin air compressors of an aircraft during flight) and input was captured by each of the sensors 106 for each second (interval) of a 10-second window of time. Thus, the input dimension to the input layer is a 240 (data measurements/points) long vector. In other embodiments, a different interval may be utilized.

The size of the input layer 112 should be set equal to the size of the input dimension to be received. In the exemplary embodiment, the size of the input layer 112 is set equal to two-hundred forty (240) neurons. The quantity of neurons 122 in the encoder layer 114 may be set in a range which results in equivalency of results from the decoder layer 116 and the input sensor data to the input layer 112. In the exemplary embodiment, the quantity of neurons 122 in the encoder layer 114 may be in the range of 60-75% of the size of the input dimension, inclusive of the endpoints of the range. For example, in the exemplary embodiment the quantity of neurons 122 in the encoder layer 114 was one hundred fifty (150). The size of the decoder layer 116 is set equal to the size of the input layer 112. For example, in the exemplary embodiment, the size of the decoder layer 116 is set equal to two-hundred forty (240) neurons. FIG. 6 illustrates an exemplary embodiment of a sliding window with input sensor data, an input layer 112, an encoder layer 114 and a decoder layer 116 and output of reconstructed sensor data.

Referring back to FIG. 2, block 220 includes training the autoencoder 104 (FIG. 1) using a set of sensor data as training data. Such training data may be separated into (a) a first portion referred to herein as the “training set” of sensor data and (b) a second portion referred to as the “holdout set” of the sensor data. The training set and the hold-out set should not contain drift as they are from the same data set of sensor data. In a preferred embodiment, the order of data (measurements) in the set of sensor data used as training data is randomized temporally. For example, if some of the measurements were captured in January and some in May, the training set will have a random mix of January and May measurements, as will the holdout set. The autoencoder 104 is trained for a plurality of iterations, using backpropagation methodologies known in the art. In the exemplary embodiment, the autoencoder 104 was trained using a thousand iterations. A greater or lesser number of iterations may be utilized, as appropriate for the backpropagation utilized.

Block 230 includes setting an initial threshold to a value “x” that is the value at a selected percentile (“percentile threshold”) of an empirical distribution of the reconstruction errors of the training set. The empirical distribution of the reconstruction errors of the training set may be generated and determined by the training controller 102a. In one embodiment, the percentile threshold may be set to a high percentile indicative of a value “x” that is unlikely to occur. In some embodiments it may be appropriate to set the initial threshold value “x” equivalent to the value associated with a percentile threshold in the range of 90^{th}-99.7^{th} percentile of the empirical distribution of the reconstruction errors of the training set after decoding by the decoder layer 116. In another exemplary embodiment, the value of the initial threshold value “x” may be set equal to the value associated with a percentile threshold that is the 99.7^{th} percentile of an empirical distribution of the reconstruction errors of the training set after decoding by the decoder layer 116. In embodiments in which the empirical distribution of the reconstruction errors for the training set is assumed to be a normal distribution, the 99.7^{th} percentile is equivalent to the mean of such empirical distribution plus three standard deviations away from the mean of the reconstruction error for the decoder layer 116 (of the autoencoder 104).

Block 240 includes assessing by the training controller 102a the initial threshold x using the holdout set of sensor data. In block 240, the holdout set of sensor data is input to the input layer of the autoencoder 104. The encoder layer 114 receives the holdout set from the input layer 112, encodes the holdout set and provides the encoded holdout set to the decoder layer 116. The decoder layer 116 decodes the encoded holdout set of sensor data. An empirical distribution of the reconstruction errors of the holdout set after decoding by the decoder layer is determined by the training controller 102a. The controller 102a compares the reconstruction errors of the holdout set of sensor data to the reconstruction errors of the training set. More specifically, the training controller 102a calculates the percentage “y” of the reconstruction errors of the holdout set that are greater than the value that was set for the initial threshold “x”.

Block 250 includes determining by the training controller 102a a final threshold for the autoencoder 104 based on the result of block 240 and Equation (1) below:

100−y=d Equation (1)
where: “y” is the percentage of the reconstruction errors of the holdout set that are greater than the value of the initial threshold “x”
   If “d” is greater than the percentile threshold, then the value of the final threshold is set equal to the value of the initial threshold “x”. Otherwise, the training controller 102a sets the value of the final threshold to be equal to the value at the inverse percentile of the percentile threshold of the holdout data.

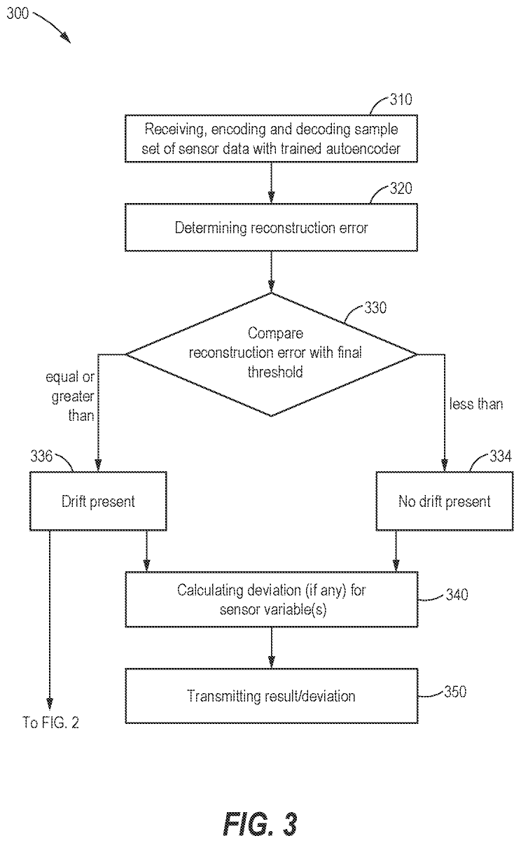

Referring now to FIG. 3 an exemplary flowchart is illustrated showing sample blocks in a method 300 to determine testing of the autoencoder 104 with a sample set of data.

Block 310 includes receiving, encoding and decoding a sample set of sensor data with the autoencoder 104. The sample set of data is received in the same format as the training data. For example, in the exemplary embodiment, the sample set of data is from twenty-four (24) sensors 106 configured to measure operating parameters of cabin air compressors of an aircraft during flight and input was captured by each of the sensors 106 for each second (interval) of a 10-second window of time, yielding a 240 datapoint vector input to the input layer.

Block 320 includes determining, by the testing controller 102b, for an empirical distribution of the reconstruction errors of the sample set (after decoding by the decoder layer) a value of the reconstruction error (e) at the percentile threshold that was previously determined for the autoencoder 104 during training.

Block 330 includes comparing by the testing controller 102b the value of the reconstruction error (e) of the sample set of sensor data determined in block 320 with the value of the final threshold that was determined with the training data. If the value of the reconstruction error (e) is less than the final threshold, the testing controller 102b determines that data drift is not present and the autoencoder 104 is trained appropriately (block 334). When the reconstruction error (e) is greater than or equal to the final threshold, the testing controller 102b determines that data drift is present in the sample set of sensor data (block 336) and the autoencoder 104 should be retained according to the method 200 of FIG. 2.

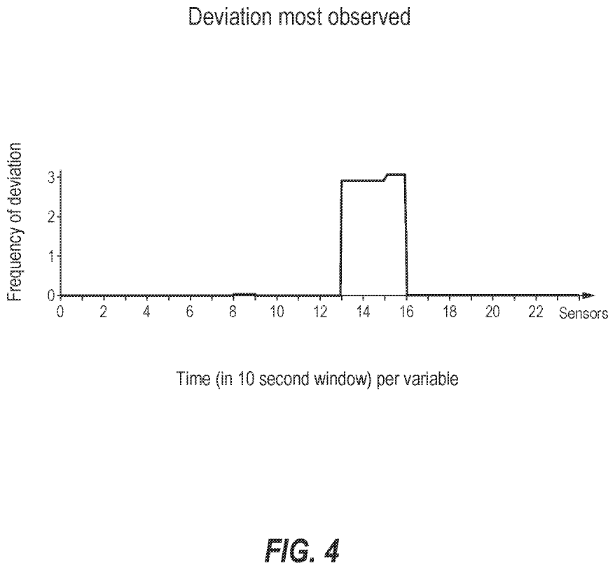

Block 340 includes calculating by the testing controller 102b a deviation output, if any, for one or more sensors in the plurality of sensors from which the sample set of sensor data was received. FIG. 4 illustrates an exemplary deviation output for each of a plurality of sensors.

Block 350 includes transmitting the result (data drift present or not present) and/or the deviation output, if any, from the testing controller 102b to the output interface 108.

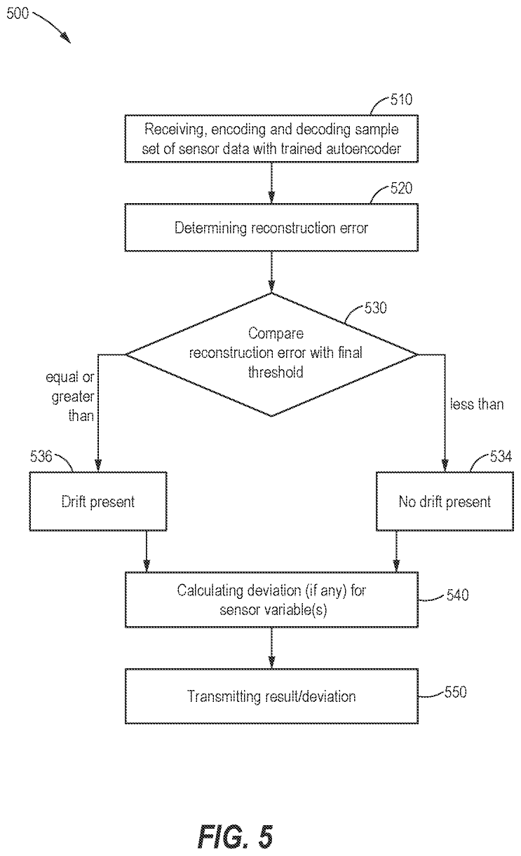

FIG. 5 illustrates a method 500 of detecting whether data drift is present using the trained and tested autoencoder 104 with a set of sensor data.

Block 510 includes receiving, encoding and decoding the set of data with the autoencoder 104. The set of data is received in the same format as the training data. For example, in the exemplary embodiment, the set of data is from twenty-four (24) sensors 106 configured to measure operating or performance parameters of cabin air compressors of an aircraft during flight and input was captured by each of the sensors 106 for each interval (in the exemplary embodiment the interval is a second) of a 10-second window of time, yielding a 240 datapoint vector input to the input layer 112.

Block 520 includes determining, by a testing controller 102c, for an empirical distribution of the reconstruction errors of the set of sensor data (after decoding by the decoder layer 116) a value of the reconstruction error (e) at the percentile threshold that was previously determined for the autoencoder 104 during training.

Block 530 includes comparing the value of the reconstruction error (e) of the set of sensor data with the value of the final threshold set for the autoencoder 104. If the value of the reconstruction error (e) is less than the final threshold, the testing controller 102c determines that data drift is not present, in block 534, then method 500 proceeds to block 540. When the reconstruction error (e) is greater than or equal to the final threshold, the testing controller 102c determines that data drift is present in the set of sensor data, in block 536, then method 500 proceeds to block 540.

Block 540 includes calculating, by the testing controller 102c, a deviation output, if any, for one or more sensors 106 in the plurality of sensors 106 from which the set of sensor data was received.

Block 550 transmitting the result (data drift present or not present) and/or the deviation output, if any, from the testing controller 102c to the output interface 108.

Also disclosed is a method 200, 300 for training 200 and testing 300 an autoencoder 104 to detect data drift. The method may comprise: training 200 the autoencoder 104 (illustrated in FIG. 2) and testing 300 the autoencoder 104 (illustrated in FIG. 3). The training 200 may include: initializing 210 the autoencoder 104, the autoencoder 104 including an input layer 112, an encoder layer 114 and a decoder layer 116 (see block 210 of FIG. 2); training 220 the autoencoder 104 based on a first portion of a first set of sensor data (see block 220 of FIG. 2); setting 230 an initial threshold to a value x at a percentile threshold of a first empirical distribution of reconstruction errors of the first portion of the first set of sensor data after decoding by the decoder layer 116 (see block 230 of FIG. 2); and determining 250 a final threshold based on a comparison of a second empirical distribution of reconstruction errors of a second portion of the first set of sensor data to the first empirical distribution of reconstruction errors of the first portion of the first set of sensor data (see block 250 of FIG. 2). The testing 300 of the autoencoder 104 with a second set of sensor data detected by one or more sensors 106 may comprise: for a third empirical distribution of reconstruction errors of the second set of sensor data after decoding by the decoder layer 116, determining 320 a first reconstruction error (e) at the percentile threshold (see block 320 of FIG. 3); determining 334 that data drift is not present when the first reconstruction error (e) of the second set of sensor data is less than the final threshold (see block 334 of FIG. 3); and calculating 340 a deviation output for at least one of the one or more sensors 106 (see block 340 of FIG. 3). In an embodiment, the method may further comprise determining 336 that data drift is present when the first reconstruction error (e) of the second set of sensor data is equal to or greater than the final threshold (see block 336 of FIG. 3).

Also disclosed is a method 200, 300, 500 for detecting drift in data captured by a plurality of sensors 106 monitoring an operation of an aircraft system 132. In an embodiment the method may comprise: training 200 a three-layer autoencoder 104 with a first set of sensor data (see FIG. 2); testing 300 the autoencoder 104 with a second set of sensor data from a second plurality of sensors 106 (see FIG. 3); and after training and testing the autoencoder 104, detecting 500 whether data drift is present in a third set of sensor data received from a third plurality of sensors 106 (see FIG. 5). The training (see FIG. 2) may include initializing 210 the autoencoder 104, the autoencoder 104 including an input layer 112, an encoder layer 114 and a decoder layer 116 (see block 210 of FIG. 2). The training 200 may further include training 220 the autoencoder 104 based on a first portion of a first set of sensor data, the first set of sensor data detected by a first plurality of sensors 106 (see block 220 of FIG. 2); setting 230 an initial threshold to a value x at a percentile threshold of an empirical distribution of the reconstruction errors of the first portion of the first set of sensor data after decoding by the decoder layer 116, wherein the percentile threshold is 90-99.7 (see block 230 of FIG. 2); comparing an empirical distribution of the reconstruction errors of a second portion of the first set of sensor data to the empirical distribution of the reconstruction errors of the first portion of the first set of sensor data (see block 250 of FIG. 2); and determining a final threshold based on a result of the comparing (see block 250 of FIG. 2). The testing 300 of the autoencoder 104 with the second set of sensor data from the second plurality of sensors 106 may comprise: receiving, encoding and decoding 310 the second set of sensor data with the autoencoder 104 (see block 310 of FIG. 3); for an empirical distribution of the reconstruction errors of the second set of sensor data after decoding by the decoder layer 116, determining 320 a value of a reconstruction error (e) at the percentile threshold (see block 320 of FIG. 3); comparing 330 the reconstruction error (e) of the second set of sensor data with the final threshold (see block 330 of FIG. 3); determining 334 that data drift is not present in the second set of sensor data when the reconstruction error (e) of the second set of sensor data is less than the final threshold (see block 334 of FIG. 3); and calculating 340 a deviation output for one or more sensors 106 in the second plurality of sensors (see block 340 of FIG. 3). In some embodiments, the detecting 500 whether data drift is present in a third set of sensor data received from a third plurality of sensors 106 may further comprise: receiving, encoding and decoding 510 the third set of sensor data with the autoencoder 104 (see block 510 of FIG. 5); for a fourth empirical distribution of reconstruction errors of the third set of sensor data after decoding by the decoder layer 116, determining 520 a second reconstruction error (e) at the percentile threshold (see block 520 of FIG. 5); comparing 530 the second reconstruction error (e) of the third set of sensor data with the final threshold (see block 530 of FIG. 5); determining 534 that data drift is not present in the third set of sensor data when the second reconstruction error (e) of the third set of sensor data is less than the final threshold (see block 534 of FIG. 5); determining 536 that data drift is present when the reconstruction error (e) of the third set of sensor data is equal to or greater than the final threshold (see block 536 of FIG. 5); and calculating 540 a deviation output for each sensor in the third plurality of sensors when data drift is present (see block 540 of FIG. 5).

### INDUSTRIAL APPLICABILITY

In general, the foregoing disclosure finds utility in applications relating to automatic detection of data drift in data collected by sensors or the like. In particular, use of the teachings herein improves the ability detect when a machine or a component may need maintenance or replacement by providing a tool that automatically detects changes in the values of the parameters monitored by sensors. The use of an unsupervised neural network (autoencoder) obviates the need for classifier labels to assess change in accuracy for drift analysis. The use of the reconstruction error (e) as a way to assess the amount of deviation (if any) in specific sensors enables identification of machines or components that may need maintenance or identification of sensors that may need to be replaced. The method disclosed herein is data-driven and does not rely on the physics of the data-generating device or machine. This is an advantage because this method can be applied to any data-generating machine and not restricted to any particular one. Because the method is data-driven, it is not necessary to identify prior to drift detection the environmental conditions under which drift appears. Furthermore, it is not necessary to compute the statistics of each individual sensor detecting data and set multiple thresholds for each sensor in order to detect drift. The method may use one threshold (final threshold) to detect drift. Some data-drift detection methods detect drift by watching how classifier results change over time. The method disclosed herein does not rely on the classifier results and thus can be used in conjunction with supervised and unsupervised classifiers (that is classifiers that do not require labels) for quicker detection of data-drift.

While the preceding text sets forth a detailed description of numerous different examples, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A data drift detection system comprising:
an autoencoder configured to receive a first set of sensor data and a second set of sensor data;
a training controller configured to:
train the autoencoder based on a first portion of the first set of sensor data;
set an initial threshold to a value x at a percentile threshold of a first empirical distribution of reconstruction errors of the first portion of the first set of sensor data after decoding by a decoder layer of the autoencoder; and
determine a final threshold based on a comparison of a second empirical distribution of reconstruction errors of a second portion of the first set of sensor data to the first empirical distribution of reconstruction errors of the first portion of the first set of sensor data; and
a testing controller configured to test the autoencoder with the second set of sensor data.

2. The system of claim 1, wherein the autoencoder includes an input layer, an encoder layer, and the decoder layer.

3. The system of claim 2, wherein the autoencoder is a three-layer autoencoder.

4. The system of claim 1, wherein the first set of sensor data and the second set of sensor data is captured by one or more sensors that monitor operation of an aircraft system.

5. The system of claim 1, wherein the percentile threshold is 90-99.7.

6. The system of claim 1, wherein to test the autoencoder with the second set of sensor data the testing controller is further configured to:
for a third empirical distribution of reconstruction errors of the second set of sensor data after decoding by the decoder layer, determine a first reconstruction error at the percentile threshold;
compare the first reconstruction error of the second set of sensor data with the final threshold; and
determine that data drift is not present when the first reconstruction error is less than the final threshold.

7. The system of claim 6, wherein the testing controller is further configured to determine that data drift is present when the first reconstruction error is equal to or greater than the final threshold.

8. A method for training and testing an autoencoder to detect data drift, the method comprising:
training the autoencoder, the training including:
initializing the autoencoder, the autoencoder including an input layer, an encoder layer and a decoder layer;
training the autoencoder based on a first portion of a first set of sensor data;
setting an initial threshold to a value x at a percentile threshold of a first empirical distribution of reconstruction errors of the first portion of the first set of sensor data after decoding by the decoder layer; and
determining a final threshold based on a comparison of a second empirical distribution of reconstruction errors of a second portion of the first set of sensor data to the first empirical distribution of reconstruction errors of the first portion of the first set of sensor data; and
testing the autoencoder with a second set of sensor data detected by one or more sensors, wherein the testing comprises:
for a third empirical distribution of reconstruction errors of the second set of sensor data after decoding by the decoder layer, determining a first reconstruction error at the percentile threshold;
determining that data drift is not present when the first reconstruction error of the second set of sensor data is less than the final threshold; and
calculating a deviation output for at least one of the one or more sensors.

9. The method of claim 8, wherein the first set of sensor data and the second set of sensor data are each based on measurements received from sensors configured to monitor operation of an aircraft system.

10. The method of claim 8, wherein setting the initial threshold includes setting the percentile threshold to 90-99.7.

11. The method of claim 8, wherein the percentile threshold is equivalent to a mean of the empirical distribution of reconstruction errors plus three standard deviations away from the mean.

12. The method of claim 8, further comprising: determining that data drift is present when the first reconstruction error of the second set of sensor data is equal to or greater than the final threshold.

13. The method of claim 8, wherein the final threshold is determined based on a percentage of the second empirical distribution of reconstruction errors of the second portion that are greater than the initial threshold.

14. The method of claim 8, wherein the input layer has a first quantity of neurons, and the decoder layer has a second quantity of neurons, wherein further the first quantity is equal to the second quantity.

15. The method of claim 14, wherein the encoder layer has a third quantity of neurons, wherein further the third quantity is 60-75% of the first quantity.

16. The method of claim 8, wherein the first set of sensor data was randomized prior to receipt by the input layer.

17. A method for detecting drift in data captured by a plurality of sensors that monitor an operation of an aircraft system, the method comprising:
training a three-layer autoencoder, the training including:
initializing the autoencoder, the autoencoder including an input layer, an encoder layer and a decoder layer;
training the autoencoder based on a first portion of a first set of sensor data, the first set of sensor data detected by a first plurality of sensors;
setting an initial threshold to a value x at a percentile threshold of a first empirical distribution of reconstruction errors of the first portion of the first set of sensor data after decoding by the decoder layer, wherein the percentile threshold is 90-99.7;
comparing a second empirical distribution of reconstruction errors of a second portion of the first set of sensor data to the first empirical distribution of reconstruction errors of the first portion of the first set of sensor data; and
determining a final threshold based on a result of the comparing;
testing the autoencoder with a second set of sensor data from a second plurality of sensors, the testing comprising:
receiving, encoding and decoding the second set of sensor data with the autoencoder;
for a third empirical distribution of reconstruction errors of the second set of sensor data after decoding by the decoder layer, determining a first reconstruction error at the percentile threshold;
comparing the first reconstruction error of the second set of sensor data with the final threshold;
determining that data drift is not present in the second set of sensor data when the first reconstruction error of the second set of sensor data is less than the final threshold; and
calculating a deviation output for one or more sensors of the second plurality of sensors; and
after training and the testing the autoencoder, detecting whether data drift is present in a third set of sensor data received from a third plurality of sensors.

18. The method of claim 17, wherein the first set of sensor data was randomized prior to receipt by the input layer.

19. The method of claim 17, wherein the aircraft system is an air compressor or an engine.

20. The method of claim 17, in which the detecting of whether data drift is present in the third set of sensor data further comprises:
receiving, encoding and decoding the third set of sensor data with the autoencoder;
for a fourth empirical distribution of reconstruction errors of the third set of sensor data after decoding by the decoder layer, determining a second reconstruction error at the percentile threshold;
comparing the second reconstruction error of the third set of sensor data with the final threshold;
determining that data drift is not present in the third set of sensor data when the second reconstruction error of the third set of sensor data is less than the final threshold;
determining that data drift is present when the reconstruction error of the third set of sensor data is equal to or greater than the final threshold; and
calculating a deviation output for each sensor in the third plurality of sensors when data drift is present.
